(19) United States
(12) Patent Application Publication
(10) Pub. No.: US 2025/0028231 A1
(43) Pub. Date: Jan. 23, 2025

(54) ROBOTIC CAMERA MOVEMENT FILMING SOLUTION

(71) Applicant: Atmata LLC, Cleveland, OH (US)

(72) Inventors: Ammar Nahari, Rocky River, OH (US); Abdulmalik Nahari, Cleveland, OH (US); Ran Hao, Cleveland Heights, OH (US); Sanjana Kamath, Somerville, MA (US); Yen-Chun Chen, Cleveland, OH (US); Chinmaya Shivaswamy, Worcester, MA (US); Tobias Cowles, Cleveland, OH (US); Robert Michael Carlstrom, Cleveland, OH (US); Justice Smith, Strongsville, OH (US); Adam Thompson, Cleveland, OH (US)

(21) Appl. No.: 18/779,920

(22) Filed: Jul. 22, 2024

Related U.S. Application Data
(60) Provisional application No. 63/514,855, filed on Jul. 21, 2023.

(51) Int. Cl. G03B 17/56; F16M 11/12; F16M 11/42

(52) U.S. Cl. CPC G03B 17/561; F16M 11/121; F16M 11/42; F16M 2200/08

(57) ABSTRACT

The present technology relates to a robotic filming system that provides an intelligent camera movement solution. The present robotic filming system may be highly portable and scalable, providing a user friendly, intelligent, and repeatable camera motion control solution. In certain embodiments, the robotic filming system may include a mechanical system, an electrical system, a human-robot control interface, and a software system. The mechanical system may include a gimbal stabilizer, a mobile platform, and a linear unit. A human-robot control interface may include a two-level control structure and include three control modes: a manual mode, a pre-programmed mode, and a repeat mode.

### CROSS-REFERENCE TO RELATED APPLICATIONS

This application claims the benefit of U.S. Provisional Application No. 63/514,855 filed on Jul. 21, 2023. The entire disclosure of the above application is hereby incorporated herein by reference.

### FIELD

The present technology relates to a robotic system that provides intelligent camera motions and filming solutions.

### INTRODUCTION

This section provides background information related to the present disclosure which is not necessarily prior art.

In traditional filmmaking, camera movement has relied upon human operators and complex equipment. However, a recent trend has emerged wherein robotic camera movement solutions are gaining increasing interest. These solutions leverage robotics and computer vision to autonomously control camera movements, thereby freeing human operators to concentrate on other facets of filmmaking.

Robotic camera movement solutions present a multitude of advantages over conventional methods. Firstly, they enhance the consistency and accuracy of camera movements, which may be crucial for attaining the desired visual aesthetic in a film. Secondly, these solutions streamline the time and labor required for scene filming. This aspect holds particular significance for large-scale productions, leading to substantial savings. Thirdly, robotic camera movement may foster creative possibilities, enabling filmmakers to capture shots that would be arduous or unfeasible with traditional techniques.

The adoption of robotic camera movement solutions may be still in its nascent stage, yet it is rapidly gaining popularity. As the technology continues to advance, further pioneering and imaginative applications of robotic camera movement in filmmaking are anticipated.

Some benefits offered by robotic camera movement solutions may include, for example, consistency and accuracy: Robotic camera movement solutions may enable consistent and precise camera movements, pivotal for achieving the desired cinematic ambiance. For example, when a filmmaker aims to execute a smoothly panning shot from left to right, a robotic camera movement device can accurately and consistently accomplish the pan.

Time and labor savings: Robotic camera movement solutions diminish the time and labor expenditure in filming a scene. Through programmed instructions, these solutions can autonomously execute intricate camera movements without necessitating human intervention. This significantly reduces the time and labor burden, particularly for large-scale productions.

Creativity: Robotic camera movement solutions unlock new vistas of creativity for filmmakers, facilitating the capture of shots that would be challenging or unattainable with traditional methods. For instance, a robotic camera movement solution can seamlessly track a moving actor through a bustling cityscape. Such a shot would present difficulties for a human operator but can be accomplished relatively easily using a robotic camera movement solution.

Overall, robotic camera movement solutions offer an array of advantages surpassing those of conventional methods. These include enhanced consistency and accuracy, time, and labor savings, and augmented creative potential. As the technology evolves, we can anticipate the emergence of even more innovative and imaginative applications of robotic camera movement in the field of filmmaking. Hence, there still exists a demand for a more cost-effective and accessible robotic camera movement solution to unlock creative possibilities for filmmakers and promote a level playing field for independent filmmakers.

### SUMMARY

In concordance with the instant disclosure, a cost-effective and accessible robotic camera movement system to unlock fresh creative possibilities for filmmakers and promote a level playing field for independent filmmakers, has surprisingly been discovered.

The present technology includes articles of manufacture, systems, and processes that relate to a mobile remote controlled gimbal stabilizer device.

In certain embodiments, a mobile filming apparatus includes a mobile base, a support base coupled to the mobile base, a linear base, and at least one controller. The mobile base may include an omnidirectional platform configured for omnidirectional movement. The support base coupled to mobile base may extend upwardly from the mobile base, the support base having an upper end and a lower end. The linear base may include a first end and a second end. The first end may be coupled to the upper end of the support base, while the second end may have a mount configured to receive an image capture device. The controller may be in communication with and configured to operate at least one of the mobile base, the support base, the linear base, and the image capture device.

In certain embodiments, a system may include a mobile base, a support base coupled to the mobile base, a linear base, at least one controller, and a remote control system in communication with the at least one controller. The mobile base may include an omnidirectional platform configured for omnidirectional movement. The support base coupled to mobile base may extend upwardly from the mobile base, the support base having an upper end and a lower end. The linear base may include a first end and a second end. The first end may be coupled to the upper end of the support base, while the second end may have a mount configured to receive an image capture device. The controller may be in communication with and configured to operate at least one of the mobile base, the support base, the linear base, and the image capture device, the remote control system permitting for a remote operation of the mobile filming apparatus by a user of the remote control system.

In still certain embodiments, a method for operating a mobile filming apparatus may include providing a mobile filming apparatus having a mobile base including an omnidirectional platform configured for omnidirectional movement, a support base coupled to the mobile base and extending upwardly from the mobile base, the support base having an upper end and a lower end, a linear base having a first end and a second end, the first end coupled to the upper end of the support base, and the second end configured to receive an image capture device, at least one controller in communication with and configured to operate at least one of the mobile base, the support base, the linear base, and the image capture device and a remote control system in communication with the controller, the remote control system permitting for remote operation of the mobile filming apparatus. The method may also include remotely controlling the mobile filming apparatus using the remote control system and moving the mobile base of the mobile filming apparatus in an omnidirectional manner using the omnidirectional platform of the mobile filming apparatus.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a block diagram showing a mobile filming apparatus, according to an embodiment of the present disclosure.

FIG. 2 is a drawing showing a front perspective view of a mobile filming apparatus, according to an embodiment of the present disclosure.

FIG. 3 is a drawing showing a side elevation view of a mobile filming apparatus, according to an embodiment of the present disclosure.

FIG. 4 is a drawing showing a side elevation view of a mobile filming apparatus, according to an embodiment of the present disclosure.

FIG. 5 is a drawing showing a front elevation view of a mobile filming apparatus, according to an embodiment of the present disclosure.

FIG. 6 is a drawing showing a rear elevation view of a mobile filming apparatus, according to an embodiment of the present disclosure.

FIG. 7 is a drawing showing a partially exploded view of a mobile filming apparatus, according to an embodiment of the present disclosure.

FIG. 8 is a drawing showing a top plan view of a mobile filming apparatus, according to an embodiment of the present disclosure.

FIG. 9 is a drawing showing a bottom plan view of a mobile filming apparatus, according to an embodiment of the present disclosure.

FIG. 10 is a drawing showing a close-up view of a mobile base of a mobile filming apparatus, according to an embodiment of the present disclosure.

FIG. 11 is a drawing showing a close-up view of a mobile base of a mobile filming apparatus illustrating the steering system, according to an embodiment of the present disclosure.

FIG. 12 is a drawing showing a close-up view of a mobile base of a mobile filming apparatus illustrating a swerve hub of the steering system, according to an embodiment of the present disclosure.

FIG. 13A is a drawing showing a close-up view of a mobile base of a mobile filming apparatus illustrating the suspension system and swerve hub, according to an embodiment of the present disclosure.

FIG. 13B is a drawing showing a close-up view of a mobile base of a mobile filming apparatus illustrating the suspension system and swerve hub, according to an embodiment of the present disclosure.

FIG. 14 is a flowchart showing a method for operating a mobile filming apparatus according to an embodiment of the present disclosure.

FIG. 15 is a block diagram showing a communication protocol for a mobile filming apparatus according to an embodiment of the present disclosure.

FIG. 16 is a flow diagram showing a human-robot control interface for a mobile filming apparatus according to an embodiment of the present disclosure.

FIG. 17 is a flow diagram for a manual control mode for a mobile filming apparatus according to an embodiment of the present disclosure.

FIG. 18 is a flow diagram for a preprogrammed control mode for a mobile filming apparatus according to an embodiment of the present disclosure.

FIG. 19 is a flow diagram for a for a mobile filming apparatus according to an embodiment of the present disclosure.

FIG. 20 is a flow diagram for a start shooting mode of for a mobile filming apparatus according to an embodiment of the present disclosure.

### DETAILED DESCRIPTION

The following description of technology is merely exemplary in nature of the subject matter, manufacture, and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology relates to apparatus, systems and methods for a mobile filming apparatus including a mobile base including an omnidirectional platform configured for omnidirectional movement, a support base coupled to the mobile base and extending upwardly from the mobile base. A linear base may be coupled to the support base. The mobile base may be configured to receive an image capture device, such as one of a still camera, and a video camera. In particular, the apparatus may be configured to receive any appropriately desired camera. The apparatus may further include a controller in communication with and configured to operate at least one of the mobile base, the support base, the linear base, and the image capture device. In certain embodiments, the apparatus may be configured as a gimbal stabilizer mobile device. The components of the apparatus may work in harmony to provide exceptional stabilization, allowing for steady and fluid movements during photography or video recording sessions.

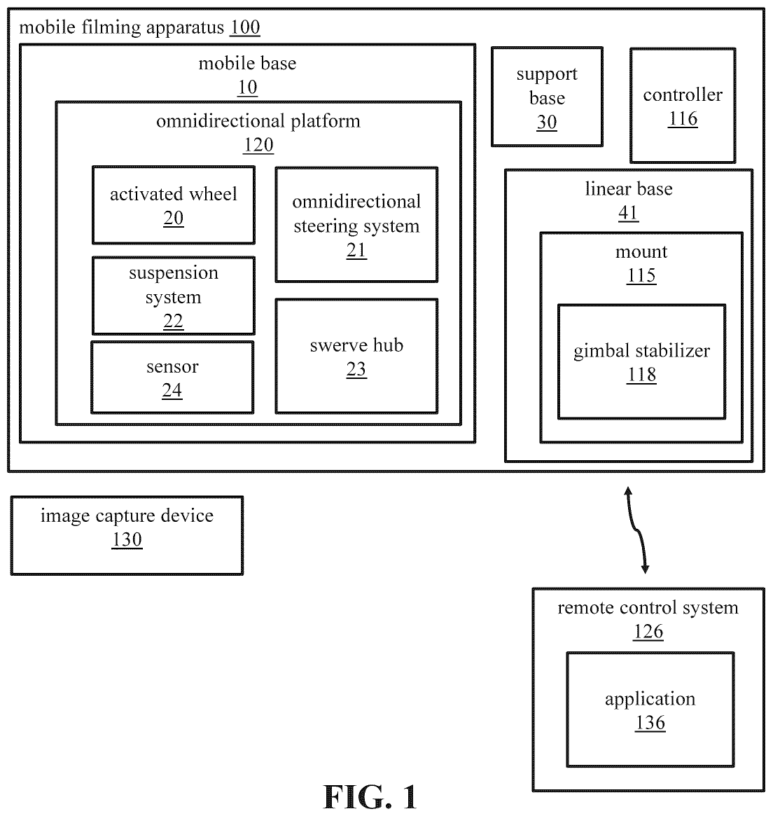

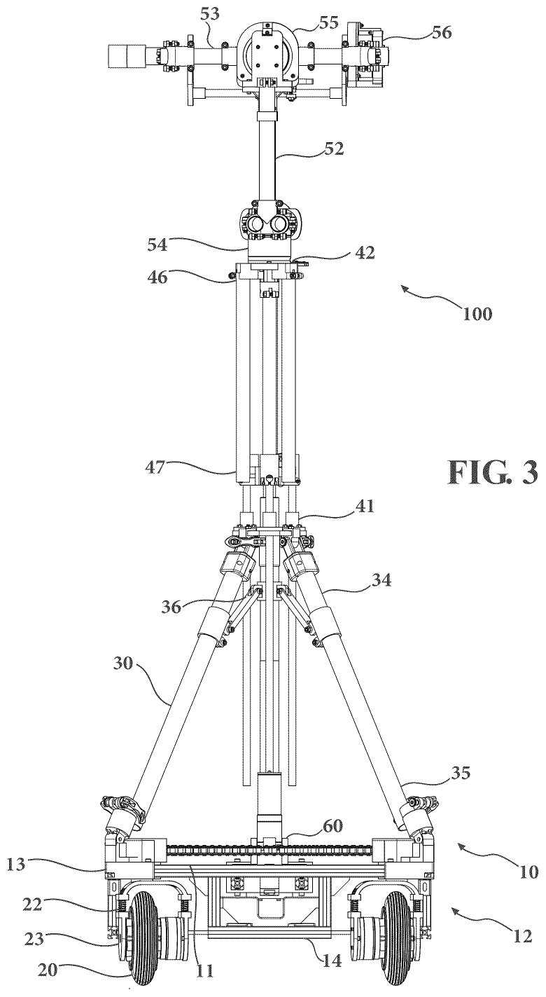

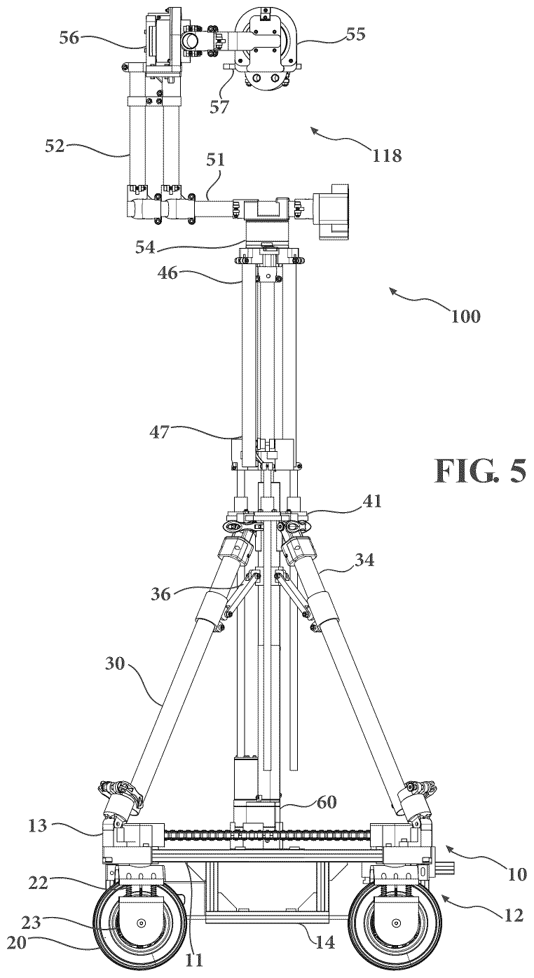

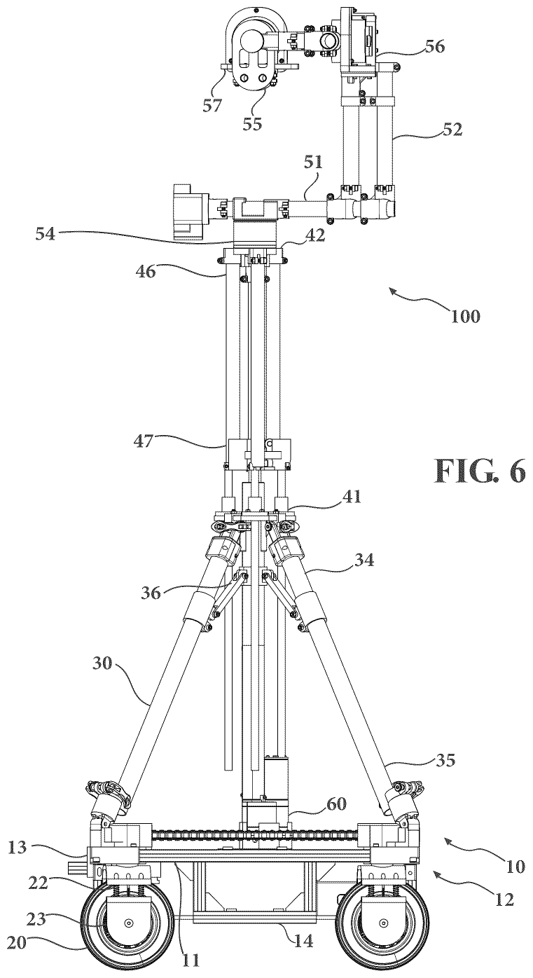

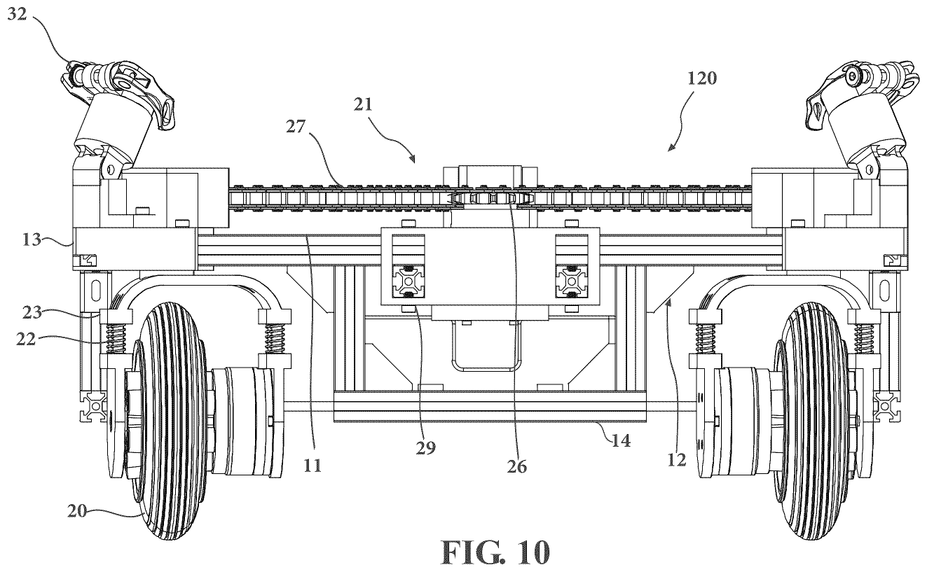

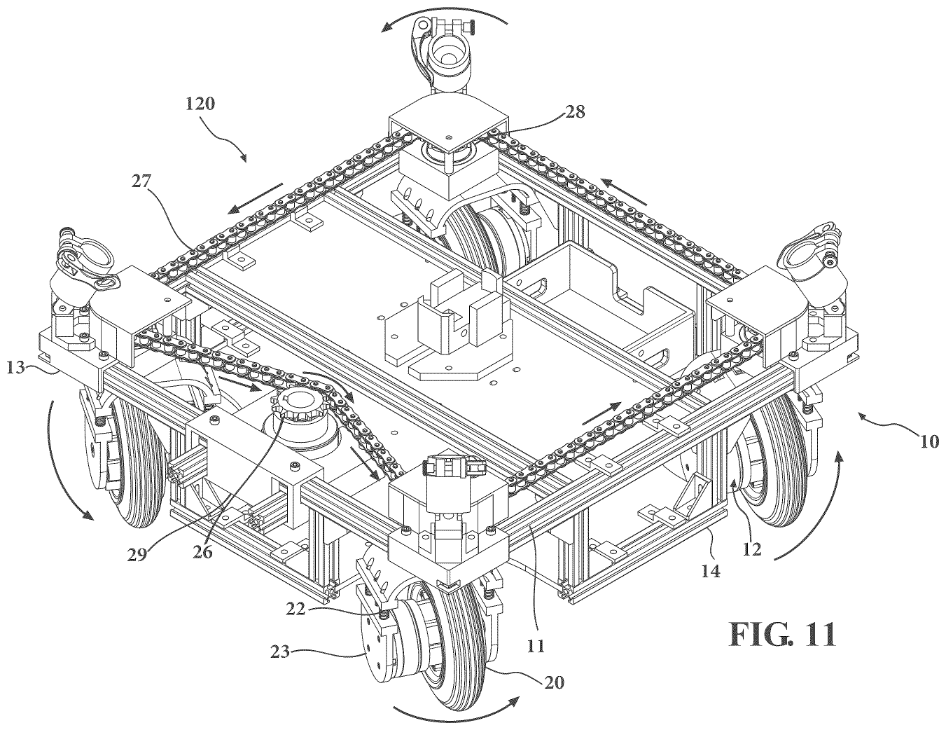

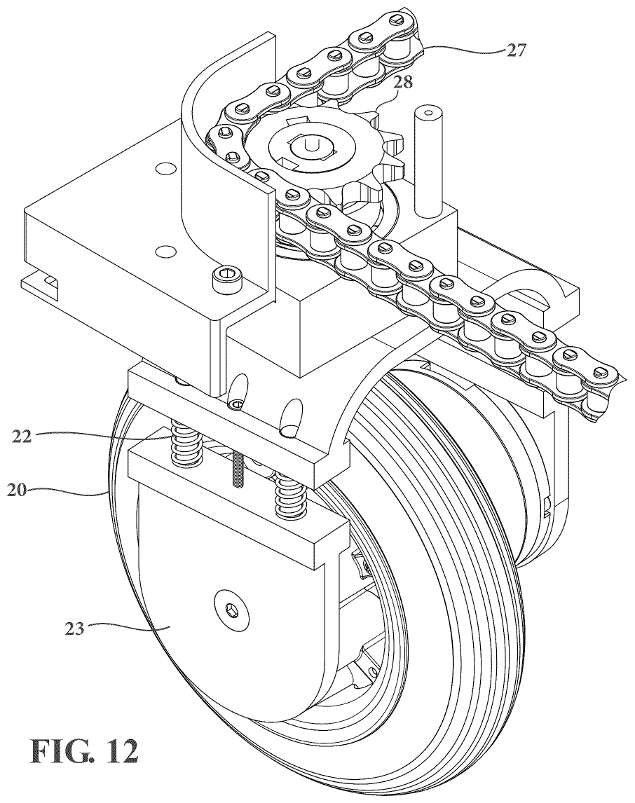

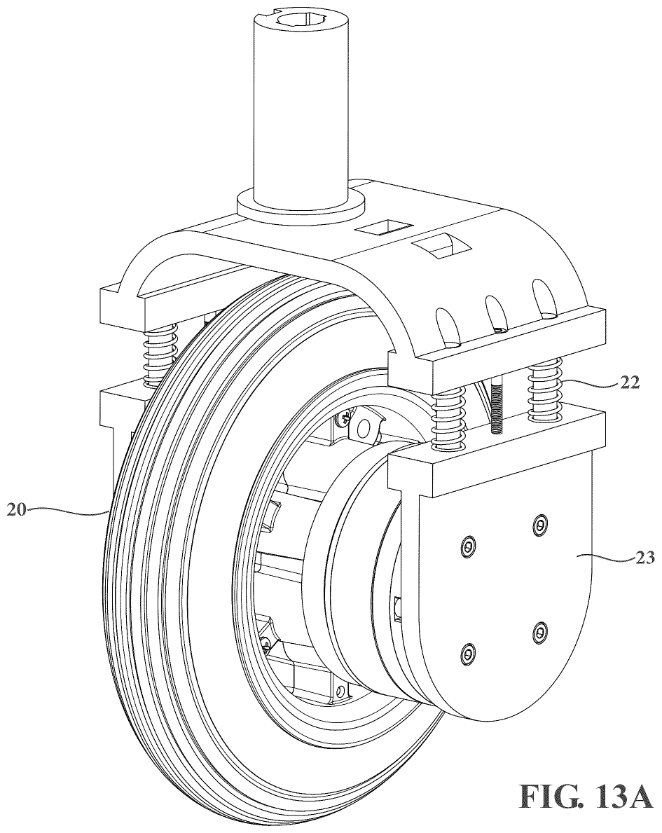

FIGS. 1-13B show embodiments of a mobile filming apparatus and system constructed in accordance with the present disclosure. As shown in FIGS. 1-13B a mobile filming apparatus 100 may include a mobile base 10, a support base 30, and a linear base 41. The mobile base 10 may include an omnidirectional platform 120 configured for omnidirectional movement. The support base 30 coupled to mobile base 10 may extend upwardly from the mobile base 10, the support base 30 having an upper end 34 and a lower end 35. The linear base 41 may include a first end 47 and a second end 46. The first end 47 may be coupled to the upper end 34 of the support base 30, while the second end 46 may have a mount 115 configured to receive an image capture device 130. The controller 116 may be in communication with and configured to operate at least one of the mobile base 10, the support base 30, the linear base 41, and the image capture device 130.

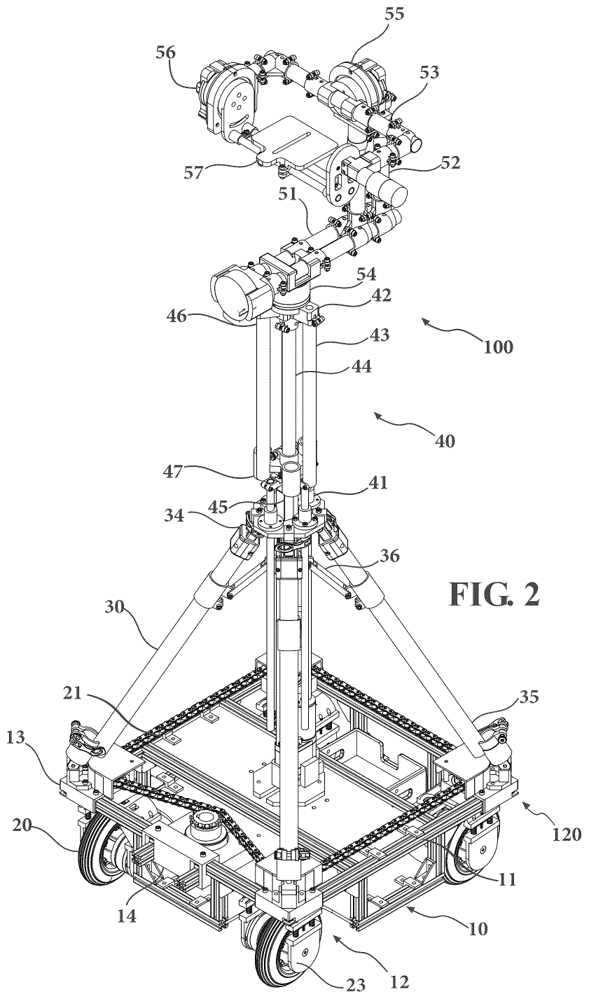

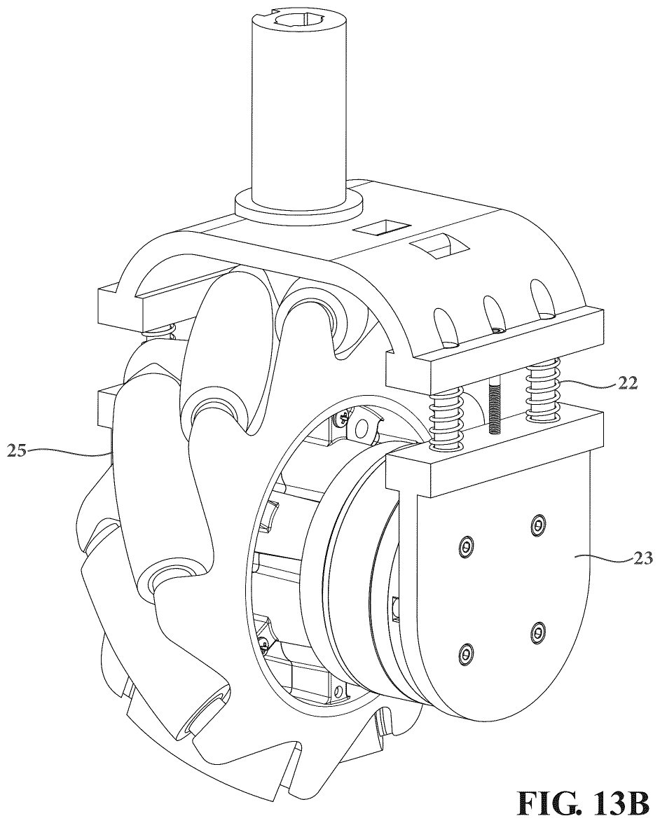

In certain embodiments, such as particularly shown within FIGS. 2, and 11-13B, the mobile base 10 may include an activated wheel 20, such as an omnidirectional wheel, a swerve hub 23, and a suspension system 22 coupled thereto. In still certain embodiment, the activated or omnidirectional wheel 20 may include a mecanum wheel 25, such as shown in FIG. 13B. In these embodiments, the mecanum wheel 25 may be configured to engage the swerve hub 23 and the omnidirectional platform 120 to provide omnidirectional mobility to the mobile base 10. An omnidirectional steering system 21 of the mobile base 10 may include a roller chain 27 and sprocket based three-dimensional steering system to enable the mobile base 10 to move in multiple directions. A suspension system 22 of the omnidirectional platform 120 may be configured to engage the activated wheel 20 and the mobile base 10 to absorb vibration. In certain embodiments. The roller chain 27 and sprocket 28 arrangement is a critical component of this steering system, allowing for smooth and precise control over the movement of the mobile base.

An operation of the omnidirectional platform 120 and steering system 21 may allow the omnidirectional platform 120 and mobile base 10 to move in rotational motion and linear motion. For example, the steering system 21 may move in a forward direction and a reverse direction as appropriately desired in order to move the mobile base when operating the mobile filming apparatus 100. Such configuration may the mobile base 10 to move laterally, pivot, and traverse without the need for extensive repositioning by an operator. The mobile base 10 and omnidirectional platform 120 may include four activated wheels 20 that provide simple spin functionality as well a translation in all directions for moving the mobile base with the steering system 21, the suspension system 22, and the swerve hub 23. This may allow the mobile base 10 and mobile filming apparatus 100 to move in tight and crowded shooting locations, where traditional movement patterns may be restricted.

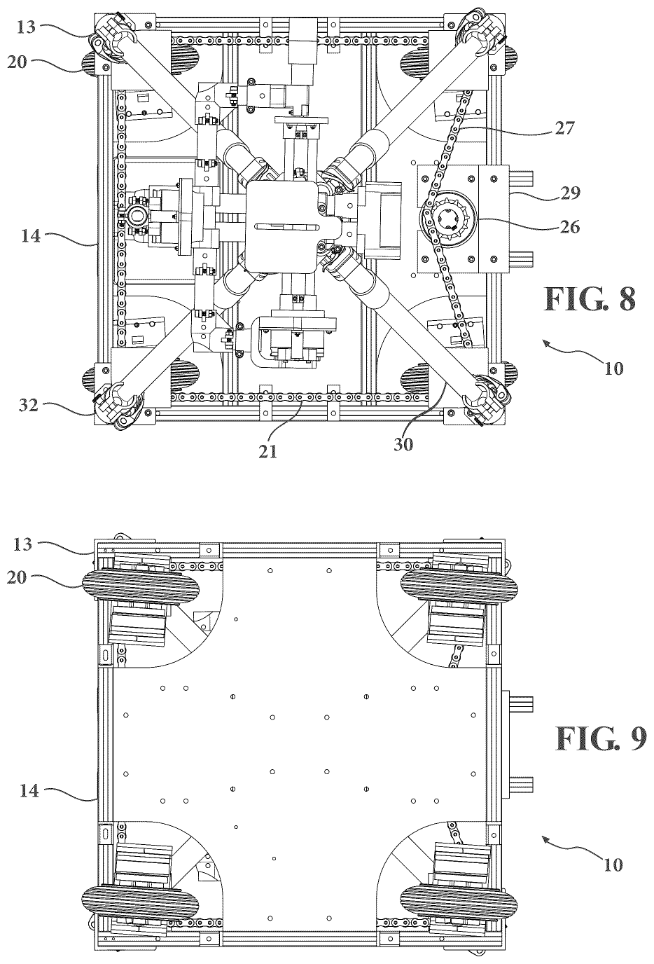

In certain embodiments, such as particularly shown within FIGS. 8 and 10-12, the omnidirectional platform 120 and omnidirectional steering system 21 may include a motor 29, the roller chain 27, and plurality of sprockets 28 at each corner of the omnidirectional platform 120. The motor 29 may be connected to the drive sprocket 26, to turn the drive sprocket 26, thus enabling the movement of the chain 27, in order to maneuver the mobile base 10 in various directions as appropriately desired. Specifically, the motor 29 may rotate the drive sprocket 26 in multiple directions in order to control a movement of the chain 27 in different directions. This The motor 29 may include various power sources such as a battery, a rechargeable battery, solar power, and other appropriately desired power sources. The omnidirectional platform 120 may include a roller chain and sprocket 28 arrangement, such as described above. However, the omnidirectional platform 120 may be chain driven, belt driven, sensor driven, or moved by other appropriately desired mechanisms.

In certain embodiments, the sensor 24 of the mobile base 10 may detect an environmental variable or other obstacle during movement of the mobile base 10. Upon receiving signals from the sensor 24, the omnidirectional steering system 21 may appropriately move and or adjust a movement of the mobile base 10. In certain embodiments, this adjustment may include an operation of the activated wheel 20 or the mecanum wheel 25 together with the swerve hub 23, and the suspension system 22, which may enable the desired movement and positioning of the omnidirectional platform 120. This may enable the mobile filming apparatus 100 to reposition the mobile filming apparatus 100 and the image capture device, as appropriately desired.

Additionally, the mobile filming apparatus 100 may include a gimbal stabilizer 118 which may be configured to secure and stabilize the image capture device 130, thereby providing additional stability and may limit the vibrations conveyed to the image capture device 130. For example, the gimbal stabilizer 118 may detachably couple to the mount 115 through the linear base 41. In certain embodiments, gimbal stabilizer 118 may have at least 4 degrees of freedom and may be height adjustable. Also, the gimbal stabilizer 118 may include a pitch rotation unit 56, a roll rotation unit 55, and a yaw rotation unit 54. The linear base 41 may be adjustable relative to the mobile base 10. For example, the linear base 41 may include a housing 42, a pair of sliders 43, a rod 44, and an actuator 45 for telescopically adjusting the linear base 41. The suspension system 22 may include an adjustable damper configured to optimize stabilization based on an operational speed of the mobile base 10. In certain embodiments, the controller 116 may be configured to synchronize operation with another mobile filming apparatus 100 for a coordinated filming operation. The coordination may occur via wireless communications between the mobile filming apparatus 100 and may incorporate sensors to detect positioning between each of the mobile filming apparatus 100 to prevent collisions, coordinate filming movements, or in other manners known to those of skill in the art. The mobile base 10 may include a sensor 24 configured to detect an obstacle. Obstacles can include other mobile filming apparatus 100, people, or potential hazards. In certain embodiments, the controller 116 may include feedback mechanism to provide automated and real-time steering adjustments for the mobile base based on terrain analysis to enable continuous filming despite the presence of hazards or obstacles.

In certain embodiments, the controller 116 may include a wireless transceiver in communication with a remote-control system 126 for a remote operation of the mobile filming apparatus. For example, the mobile filming apparatus 100 may include a user interface that may be accessible via a remotely located mobile application 136. The mobile application 136 may include one or more application controls, such as a navigation page, workstation page, real-time filming statistics, one or more control modes. In particular, the mobile application 136 may include a plurality of application controls as appropriately desired for controlling the functions of the mobile filming apparatus. For example, in certain embodiments, the remote-control system 126 may be configured to execute a pre-programmed motion path of the mobile base 10. In certain embodiments, the pre-programmed motion path of the mobile base 10 may be generated by an AI model in at least one of the controller 116 and the remote-control system 126.

As shown in FIG. 2, the mobile base 10 is generally polygonal-shaped, such as a square. The mobile base 10 may include an upper surface 11, a lower surface 12, a set of wheel brackets 13, and a base frame 14. The wheel brackets 13 may be securely mounted to the lower surface 12, providing stability and maneuverability to the entire system. Meanwhile, the base frame 14 may be affixed to the upper surface 11, acting as the structural backbone of the mobile base 10. In certain embodiments, the wheel brackets 13 may include the omnidirectional wheels 20, such as a mecanum wheel, which may possess omnidirectional capabilities. The omnidirectional wheels 20 may enable the mobile filming apparatus 100 to move in any direction, thus allowing a user to navigate various terrains and positions while maintaining stability when moving the mobile filming apparatus 100.

In certain embodiments, the base frame 14, may provide structural support to the mobile filming apparatus 100. The base frame 14 may be affixed to the upper surface 12 of the mobile base 10, in order to provide rigidity and stability during operation of the mobile filming apparatus 100. The design of the base frame 14 may vary; for example, it may be constructed as a single piece or multiple pieces that are formed and integrated to function as a single unit. This integration may further contribute to the overall durability and functionality of the mobile base 10. Additionally, the base frame 14 may be a part of the lower surface 12 of the mobile base 10, which further increase a strength of the mobile base 10, and act to support various attachments and components critical for the omnidirectional capabilities and operational efficiency of the mobile filming apparatus 100.

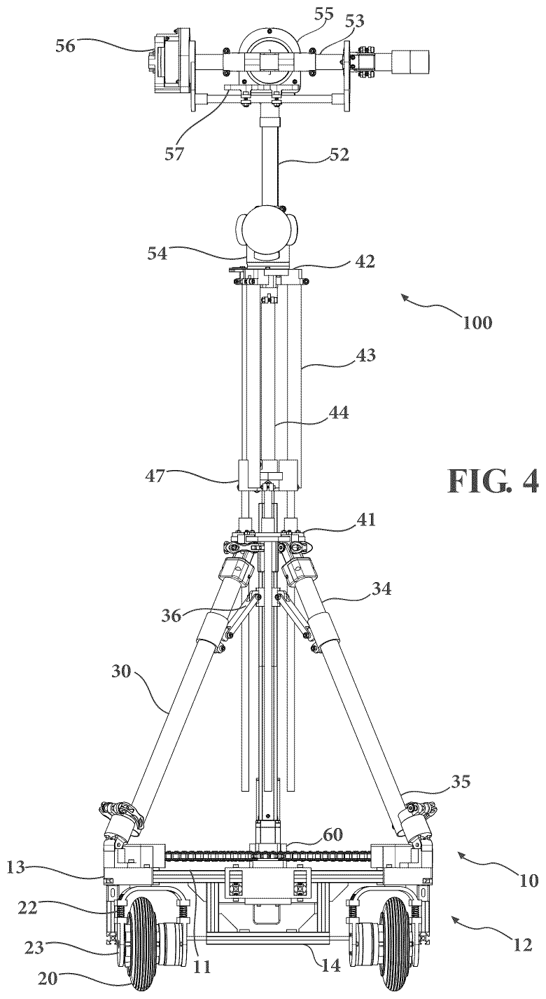

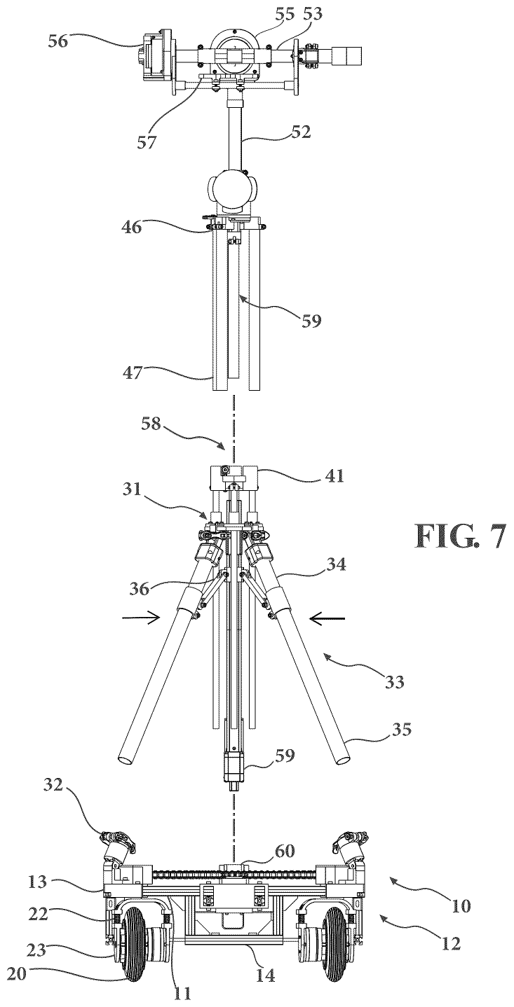

The support base 30 of the mobile filming apparatus 100 may further include one or more folding joints 31, folding locks 32, and folding links 33, which may offer flexibility and compactness for transportation and storage. The folding locks 32 may be mounted to the base frame 14, while the folding links 33 may be axially removably attached to the folding locks 32. This arrangement may allow the support base 30 to fold radially, such as shown by the arrows in FIG. 7, thus an overall size of the mobile filming apparatus 100 when not in use. In particular, in certain embodiment links 33 may fold radially using a folding joint 36, such as shown in FIGS. 4-7. As further shown in FIG. 7, a detaching connector 59 of the support base 30 may be inserted into a receiver 60 of the mobile base 10 to securely attach the support base 30 with the mobile base 10.

A linear unit 40 of the mobile filming apparatus 100, such as shown in FIG. 2, may include the linear base 41, a housing 42, a pair of sliders 43, a rod 44, and an actuator 45. The linear base 41 may be mounted to the folding joints 31 and the support base 30, thus forming a rigid connection between these elements. The housing 42 may be affixed to the rod 44, which, in turn, may be parallelly movable to the actuator 45. The sliders 43 may enable parallel movement between the linear base 41 and the housing 42, in order to facilitate precise adjustments and smooth linear motion.

In particular, the linear unit 40, with a rigid structure, may facilitate precise movements of the mobile filming apparatus 100, which may be crucial for high-quality filming. The linear base 41 may include a rigid connection with the support base 30 and the mobile base 10 that enhances the stability of the entire unit, such as where the support base 30 may be inserted into a receiver 60 of the mobile base 10 to securely attach the support base 30 with the mobile base 10\, as described above. In particular, the rigid connection may include any appropriately desired connection for attaching the linear base 41 to the support base 30. For example, this may include a bolted connection, a welded connection, one or more interlocking mechanisms, brackets, flanged connections, and other connections as appropriately desired.

The housing 42, affixed to the rod 44, allows for parallel movement relative to the actuator 45, facilitated by the sliders 43. This setup enables the linear unit 40 to execute smooth and precise linear motions, essential for achieving the desired camera angles and positions with minimal vibration and maximum control.

The mobile filming apparatus 100 may further include a longitudinal bar 51, a vertical bar 52, a lateral bar 53, a yaw rotation unit 54, a roll rotation unit 55, a pitch rotation unit 56, a device platform 57, a detaching lock 58, and a detaching connector 59. The yaw rotation unit 54 may be horizontally movable and mounted to the housing 42. Connected to the yaw rotation unit 54, the longitudinal bar 51 may provide rotational support as the mobile filming apparatus 100 rotates as appropriately desired. The vertical bar 52 may be vertically mounted to the longitudinal bar 51, thus providing stability in the vertical axis for the mobile filming apparatus 100.

The roll rotation unit 55 may be vertically movable and attached to the vertical bar 52, thus enabling controlled roll movements for the mobile filming apparatus 100. The lateral bar 53 may be horizontally movable and connected to the roll rotation unit 55, in order to enhance lateral stability of the mobile filming apparatus 100. The pitch rotation unit 56 may be mounted to the lateral bar 53, in order to enable the smooth pitch movements.

In certain embodiments, the gimbal stabilizer 118 may feature a detaching lock 58 on the yaw rotation unit 54 for quick and secure attachment and detachment of the device platform. A detaching connector 59 on the longitudinal bar 51 may allow for a detachment and an attachment of the image capture device 130. Finally, the device platform 57, which may mount the image capture device 130 may be affixed to the pitch rotation unit 56.

In certain embodiments, a 24V battery may be employed in order to power 4 mobile motors (M1-M4) and three gimbal motors (G1-G3). The four mobile motors and a linear actuator are connected to an Arduino mega microcontroller. An inertial measurement unit (IMU) may be positioned on a base of the mobile filming apparatus 100 which may be powered by and communicates with an Arduino mega microcontroller. In certain embodiments, three gimbal motors may be controlled by a second Arduino mega microcontroller. In certain embodiments, one or more additional IMUs may be positioned on the gimbal stabilizer, which are and may be powered by the Arduino mega microcontroller on the gimbal stabilizer 118. In certain embodiments, the Arduino nega microcontrollers may be powered and controlled by a NVIDIA Jetson Nano™, (or other similar artificial intelligence controller and/or microcontroller as appropriately desired). A second linear voltage regulator may step the voltage down to 5V in order to power the Jetson Nano™.

The controller 116 interface may include a two-level control structure. For example, a 7 Degree of Freedom (DoF) robot control problem, including: 1) a 3 DoF control problem for the mobile platform, which controls the x and y directions, and the heading angle of the mobile platform; and 2) a 4 DoF control problem for the gimbal stabilizer system, which controls the z direction, roll, pitch, and yaw of the gimbal. The present two-level control structure may include a low-level feedback motor control system and a high-level motion control system. In the low-level feedback control system, the controller 116 may use an input including Pulse-Width Modulation (PWM) signals and regulate a motor velocity and position using feedback signals from a built-in motor encoder by employing a PID control strategy. In the high-level feedback control system, the controller 116 may use the input of the provided user commands and regulate the positional and angular states of the mobile filming apparatus 100 using feedback signals provided by embedded IMU sensors. Specifically, for the control of the mobile base 10, a mobile IMU sensor or other appropriately desired sensor 24 placed at a center of the mobile base 10 may return x, y positions and heading data and other directions of the mobile base 10. The controller 116 may employ improved Tau-G control strategy and calculate a series of reference trajectories. A PID or other appropriately desired controller may be applied in order to calculate a corresponding desired mobile motor velocities for achieving a reference trajectory. For the control of the mobile filming apparatus 100, a gimbal IMU sensor may return the z position, roll, pitch, and yaw data of the mobile filming apparatus 100. The controller may employ an improved Tau-G control strategy and a PID controller to compute a series of desired motor velocities to achieve a given desired gimbal configuration accurately.

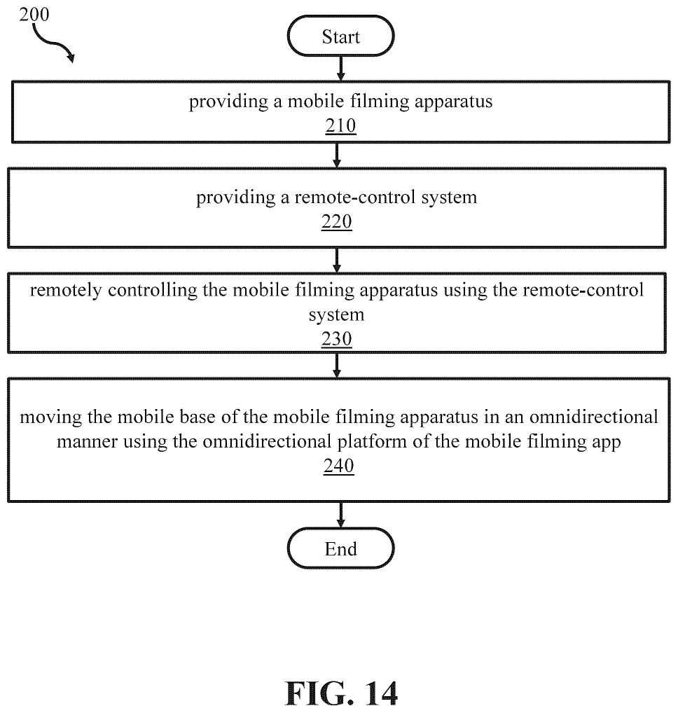

With reference to FIG. 14, a method 200 for operating a mobile filming apparatus 100 is shown therein. As shown in FIG. 14, at the step 210, a mobile filming apparatus 100, such as described above, may be provided. Then, in the step 220, a remote-control system 126 for the mobile filming apparatus 100 may be provided. In the step 230 the mobile filming apparatus 100 may be remotely controlled using the remote-control system 126 and in the step 240, the mobile base 10 of the mobile filming apparatus 100 may be moved in an omnidirectional manner using the omnidirectional platform 120 of the mobile filming apparatus.

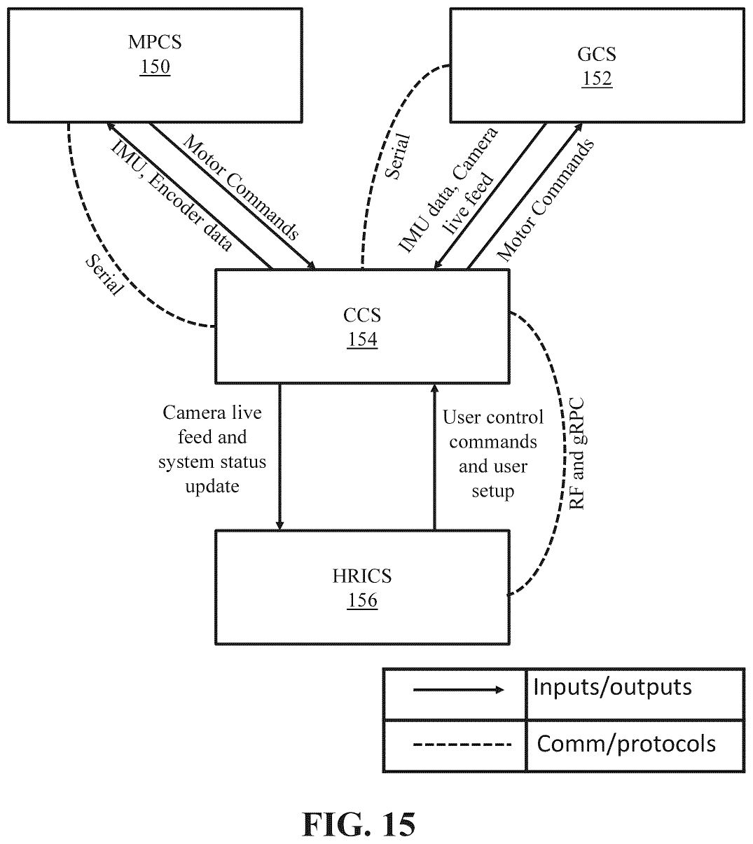

A software structure of the robotic filming system is presented in FIG. 15. In the illustrated embodiment, the software system may include four components: a mobile platform control system (MPCS) 150, a gimbal control system (GCS) 152, a human-robot interface control system (HRICS) 156, and a central control system (CCS) 154.

The CCS 154 may employ a Robot Operating System (ROS) as a fundamental operating system and system communication framework. The CCS 154 may control the three subsystems of the filming system, i.e., MPCS 150, GCS 152, and the HRICS 156. As the central computing unit of the robotic filming system, the CCS 154 may receive the sensing feedback data from the subsystems, processes feedback data, calculates the control commands based on the specific tasks, and sends the control commands back to the sub-systems for execution.

The MPCS 150 may control the 2D planar motion and the vertical motion of the mobile filming apparatus 100 through the omnidirectional platform 120 and a linear actuator. The MPCS 150 may communicate with the CCS 154 using a ROS serial TCP protocol. Specifically, the MPCS 150 may receive real-time motor position commands from the CCS 154, and send the linear positional (x and y directional) IMU data and potentiometer data (z directional) of the linear actuator to the CCS 154.

The GCS 152 may control and stabilize a motion of the camera gimbal system. The gimbal system may communicate with the CCS 154 using the ROS serial TCP protocol. Specifically, the GCS 152 may send angular IMU sensing feedback of the image capture device 130 pose and image capture device 130 live feed to the CCS 154 and receive real-time motor position commands from the CCS 154.

The HRICS 156 may include a RF remote controller unit and a web/mobile application which may allow the user to interact with the mobile filming apparatus 100 directly. The HRICS 156 may communicate with the CCS 154 using a TCP/IP protocol. The RF remote controller may send control commands to the RF receiver unit of the CCS 154. The web/mobile application may send the mobile filming apparatus 100 motion parameters and other user setups to the CCS 154, while receiving real-time mobile filming apparatus 100 status feedback data and camera live feed from the CCS 154.

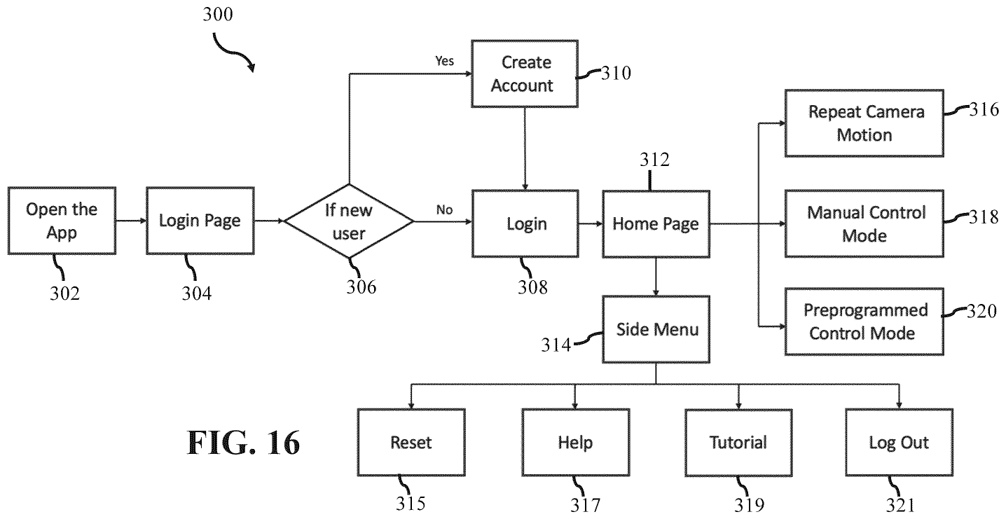

With reference to FIG. 16, a human-robot control interface 300 for the mobile filming apparatus 100 is shown. The human-robot control interface 300 starts by opening an application 302 and displaying the company name and logo for a few seconds. This display automatically fades away to reveal the login page 304. At this page, if a new user 306, the users are invited to log in 308 with their credentials or create an accounts 310 Upon logging in, the user may be taken to the home page 312. The home page 312 may consist of three options for operating the mobile filming apparatus 100: manual Control Mode 318, pre-programmed control mode 320, and repeat camera motion 316. A side menu 314 may be provided, displaying the following options-tutorial 319, help 317, reset 315, and log out 321. In which, the reset 315 option may clear out the current storage of the mobile filming apparatus 100 motions and reset the parameters of the mobile filming apparatus 100 system to default.

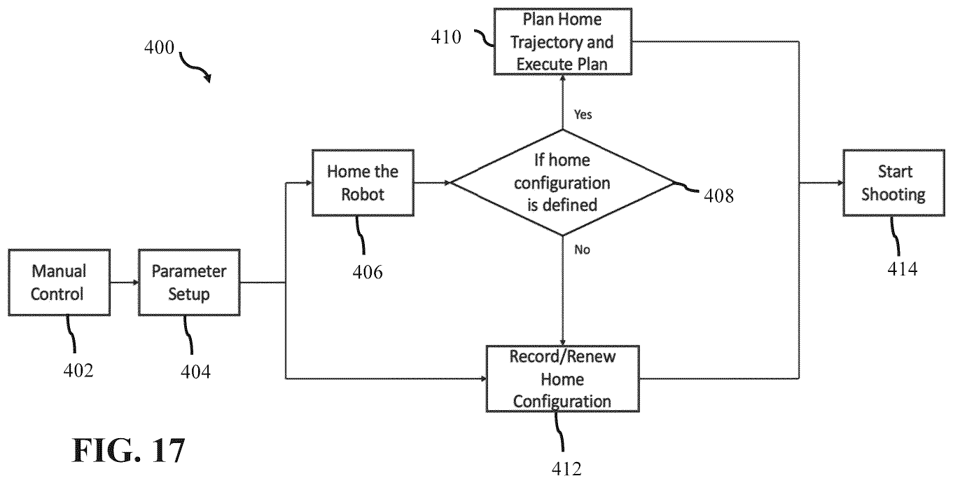

With reference to FIG. 17, a manual control mode 400 is depicted therein. The manual control mode 400 allows the user to control the mobile filming apparatus 100 by sending motion commands from a radio frequency remote control station. With manual control 402, the user may be first led to the parameter setup page 404, where the user may be guided to set up the mobile filming apparatus 100 motion parameters including mobile platform speed, camera pan speed, etc. After the parameter setup, the user may be guided to either home the robot 406 or record/renew a home configuration 412 of the mobile filming apparatus 100 as a start configuration of the shooting. In the record/renew home configuration 412 option, the control interface allows the user to choose a desired pose of the robot as a starter point of the shooting process. The home configuration recording may be achieved through storing the instantaneous IMU sensing feedback of the robot configuration. In the home the robot 406 option, the control interface may automatically check if there may be a home configuration defined 408. If a home configuration may be available and accepted by the user, the control interface plans a set of gimbal and mobile platform trajectory or plan home trajectory and execute plan 410 using an iterative Linear Quadratic Gaussian algorithm (iLQG) from the current the mobile filming apparatus 100 configuration (reported by a sensor) to the given home configuration. Otherwise, the control interface requires the user to record a new home configuration. After the home configuration may be achieved or recorded, the user may be guided to start shooting 414.

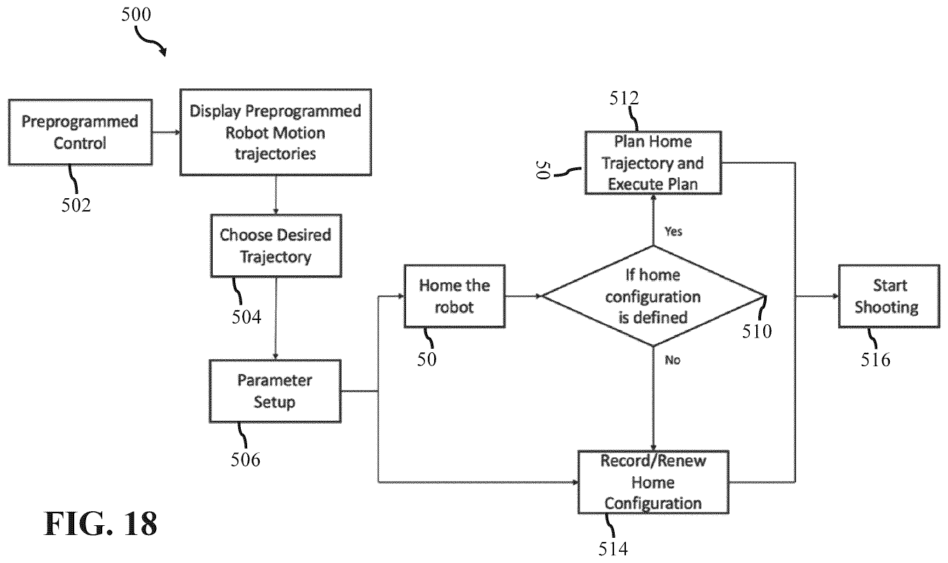

In a pre-programmed control mode 500, such as shown in FIG. 18. The pre-programmed control 502 allows the user to choose a camera trajectory from a pool of predefined camera trajectories 503. This control mode aims to provide preset camera motions that are simple yet frequently used for the user, such as circular camera motions, pan, tilt, and pedestal camera movement, etc. The user may be first guided to a page that displays all available predefined motions to choose a desired trajectory 504. Upon choosing a desired camera motion, the user may be led to the parameter setup page 506 and guided to set up the related motion parameters based on the selected predefined motion. Similar to the manual control mode, the user can choose to either home 508 the mobile filming apparatus 100 or record/renew a home configuration 514 of the robot as a start configuration for the shooting. If the home configuration 510 may be defined, the user may plan a home trajectory and execute the plan 512. If the home configuration may not be defined the home configuration may record or be renewed 514. After the home configuration may be achieved or recorded, the user may be guided to the start shooting 516.

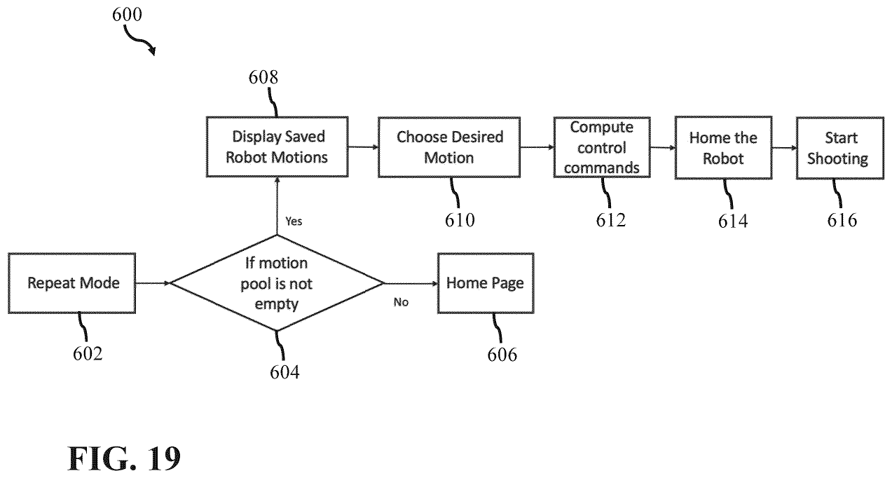

A repeat mode 600 is presented in the diagram shown in FIG. 19. The repeat mode 602 may be designed to repeat the camera motions required by the user. The repeatability of the camera motions may enable a capability of achieving precise sequences of desired shots, greatly facilitating the with actor-without actor scene assessments, video editing, and other post-production works. In the repeat mode 600, the present control interface first checks if the camera motion pool may be empty. If motion pool is not empty 604, the user is guided back to the home page 606. Otherwise, the interface displays a pool of saved robot trajectories 608. Upon choosing a desired motion 610 for repetition, the control interface first employs the Tau-G algorithm and calculates a series of control commands 612 for achieving the repetition of desired robot motion trajectory to home the robot 614. The control interface proceeds to guide the robot back to the home configuration of the chosen trajectory. The user may then be guided to start shooting 616.

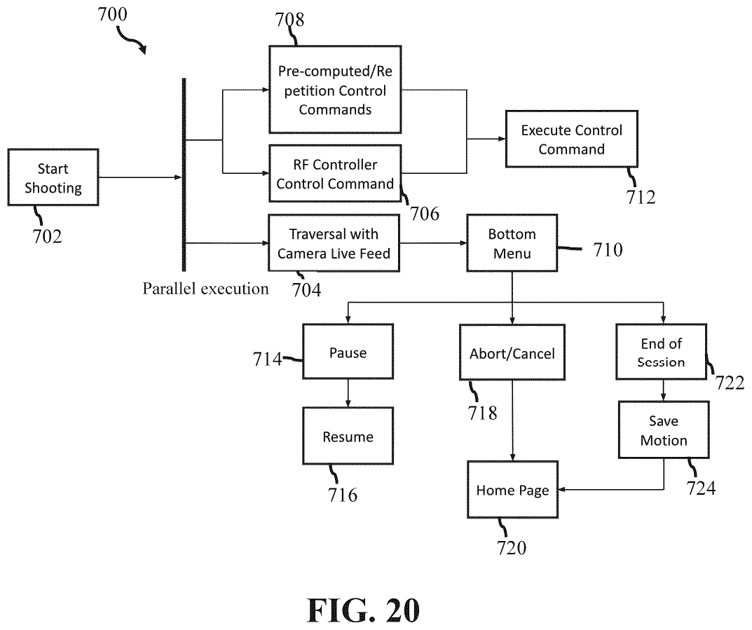

A start shooting process 700 may be presented in the diagram shown FIG. 20. Upon selecting the start shooting mode 702, the control interface executes the control commands sent from the user (in manual control mode), or the control commands computed and adjusted according to the precomputed trajectory 708 and user defined parameters (in pre-programmed control mode), RF controller command 706, traversal with camera live feed 704, or the repeat control commands (in repeat mode), and simultaneously display the live feed from the camera in a parallel manner. A bottom menu 710 may be presented at the bottom of the live feed page. The bottom menu 710 may provide three options: pause 714, cancel 718, and end of session 722. In the pause 714 option, the present control interface performs a temporary halt on the motion execution, where the user can resume 716 the shooting process at any point. The cancel 718 option stops the current motion execution and leads the user back to the home page. In the end of session 722 option, at the end of the shooting session, the present control interface has a save motion 724 that saves the gimbal and mobile platform motions by storing the feedback data reported during the shooting process from the IMU sensors at an optimized sample rate. Upon saving the reported robot motions, the user may be guided back to the home page 720.

Advantageously the software and hardware structure of the present technology may be designed to be modular and scalable, which may allow the present apparatus, system, and method to be easily upgraded and easily adaptable to different tasks and environments.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions, and methods can be made within the scope of the present technology, with substantially similar results.

What is claimed is:

1. A mobile filming apparatus comprising:
a mobile base including an omnidirectional platform configured for omnidirectional movement;
a support base coupled to the mobile base and extending upwardly from the mobile base, the support base having an upper end and a lower end;
a linear base having a first end and a second end, the first end coupled to the upper end of the support base, and the second end having a mount configured to receive an image capture device; and
at least one controller in communication with and configured to operate at least one of the mobile base, the support base, the linear base, and the image capture device.

2. The mobile filming apparatus of claim 1, wherein the mobile base includes an activated wheel, a swerve hub, and a suspension system coupled thereto.

3. The mobile filming apparatus of claim 2, wherein the activated wheel includes a mecanum wheel.

4. The mobile filming apparatus of claim 3, wherein the mecanum wheel is configured to engage the swerve hub and the omnidirectional platform to provide omnidirectional mobility to the mobile base.

5. The mobile filming apparatus of claim 2, wherein the suspension system is configured to engage the activated wheel and the mobile base to absorb vibration.

6. The mobile filming apparatus of claim 1, wherein the mobile filming apparatus includes a gimbal stabilizer configured to the image capture device, the gimbal stabilizer detachably coupled to the mount at the second end of the linear base.

7. The mobile filming apparatus of claim 6, wherein the gimbal stabilizer has at least 4 degrees of freedom and is height adjustable.

8. The mobile filming apparatus of claim 2, wherein the suspension system includes an adjustable damper configured to optimize stabilization based on an operational speed of the mobile base.

9. The mobile filming apparatus of claim 1, wherein the at least one controller is further configured to synchronize operation with least one other mobile filming apparatus for a coordinated filming operation.

10. The mobile filming apparatus of claim 1, wherein the mobile base further includes at least one sensor configured to detect an obstacle.

11. The mobile filming apparatus of claim 1, wherein the at least one controller has a feedback mechanism to provide automated and real-time steering adjustments for the mobile base based on terrain analysis.

12. A mobile filming system, comprising
a mobile filming apparatus including
a mobile base including an omnidirectional platform configured for omnidirectional movement,
a support base coupled to the mobile base and extending upwardly from the mobile base, the support base having an upper end and a lower end,
a linear base having a first end and a second end, the first end coupled to the upper end of the support base, and the second end configured to receive an image capture device, and
at least one controller in communication with and configured to operate at least one of the mobile base, the support base, the linear base, and the image capture device; and
a remote control system in communication with the at least one controller, the remote control system permitting for a remote operation of the mobile filming apparatus by a user of the remote control system.

13. The mobile filming system of claim 12, wherein the at least one controller includes a wireless transceiver in communication with a remote control system for a remote operation of the mobile filming apparatus.

14. The mobile filming system of claim 12, wherein the mobile filming apparatus includes a user interface accessible via a remotely located mobile application.

15. The mobile filming system of claim 12, wherein the remote control system is configured to cause the at least one controller to execute a pre-programmed motion path of the mobile base.

16. The mobile filming system of claim 15, wherein the pre-programmed motion path of the mobile base is generated by an AI model in at least one of the controller and the remote control system.

17. A method for operating a mobile filming apparatus, the method comprising:
providing a mobile filming apparatus having
a mobile base including an omnidirectional platform configured for omnidirectional movement,
a support base coupled to the mobile base and extending upwardly from the mobile base, the support base having an upper end and a lower end,
a linear base having a first end and a second end, the first end coupled to the upper end of the support base, and the second end configured to receive an image capture device, and
at least one controller in communication with and configured to operate at least one of the mobile base, the support base, the linear base, and the image capture device; and
a remote control system in communication with the controller, the remote control system permitting for remote operation of the mobile filming apparatus;
providing a remote control system in communication with the at least controller of the mobile filming apparatus, the remote control system permitting for a remote operation of the mobile filming apparatus by a user of the remote control system;
remotely controlling the mobile filming apparatus using the remote control system; and
moving the mobile base of the mobile filming apparatus in an omnidirectional manner using the omnidirectional platform of the mobile filming apparatus.

18. The method of claim 17, wherein moving the mobile base includes activating a wheel, engaging a swerve hub, and utilizing a suspension system of the mobile filming apparatus.

19. The method of claim 17, wherein the remote control system includes using a wireless communication module for the remote operation.

20. The method of claim 17, wherein the remote control system executes a pre-programmed motion path.
